(19) United States
(12) Patent Application Publication
(10) Pub. No.: US 2008/0250878 A1
(43) Pub. Date: Oct. 16, 2008

(54) Scent evidence transfer device

(76) Inventor: Vincent Montefusco, Crowley Lake, CA (US)

Correspondence Address: IRVING KESCHNER, 21535 HAWTHORNE BOULEVARD, SUITE 385, TORRANCE, CA, 90503, US

(21) Appl. No.: 11/786,273

(22) Filed: Apr. 12, 2007

(51) Int. Cl. G01N 1/24

(52) U.S. Cl. 73/864.34

(57) ABSTRACT

A compact and portable scent transfer device. The device comprises a housing, a motor/fan combination, a sterile pad holder connected to the housing and a sterile pad removably coupled to the sterile pad holder. A number of embodiments having these features are disclosed.

### BACKGROUND OF THE INVENTION

1. Field of the Invention

The present invention relates to a device for collecting scents from a scene and enabling trained dogs to sniff the collected scent and then hunt for criminals or missing persons.

2. Description of the Prior Art

U.S. Design Pat. No. 397,051, issued on Aug. 18, 1998, discloses a scent evidence device which includes a pad holder, the function of the device being to collect scent from a crime scene on a pad and thereafter make the pad available to a trained dog to hunt for criminals or missing persons.

Although the patented device works satisfactorily, it is relatively large and requires an electric motor to generate a vacuum.

Copending application Ser. No. 11/545,941, filed Oct. 12, 2006, discloses a scent transfer device which is more compact than the prior art design and wherein an electric motor is not utilized to generate the required vacuum.

The device comprises an air inflator having a gas cartridge, the inflator being coupled to an air amplifier. A holder having a sterile pad positioned therein is secured to the air amplifier. When gas from the cartridge is expelled into the air amplifier, a vacuum is created at the end of the air amplifier where the pad holder is attached, enabling a user, when the pad holder is positioned near an area to be examined, to collect the scent on the pad. The pad can then be removed and stored in an evidence bag. The use of gas cartridges eliminates the necessity of using air to create the vacuum which could contaminate the pad and also enables the generated vacuum to be precisely metered each time the device is used.

Although the device set forth in the '941 application performs well, it is desired to provide a scent transfer unit that is compact and portable.

### SUMMARY OF THE PRESENT INVENTION

The present invention provides a compact and portable scent transfer device. The device comprises a housing, similar to that of a portable electric drill, a motor/fan combination, a sterile pad nozzle component holder connected to the housing, a sterile pad nozzle having a sterile member pad therein coupled to nozzle component holder and a nozzle coupled to the nozzle member. An exhaust port is formed in the device housing. The housing is fabricated in a manner such that it can be connected to a conventional rechargeable battery.

In an alternate embodiment, a disposable capsule, or cartridge is mounted to the housing in place of the sterile pad nozzle and component holder, the capsule having removable caps on both ends. A sterile pad is secured within the capsule. The capsule is inserted into the front of the housing and secured therein during the collection process. One end of the capsule is punctured when inserted into the housing, indicating usage and avoiding possible re-use and/or cross-contamination. The capsule can also be mounted to one end of an extension, the other end inserted into the collection end of the housing.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a first embodiment of the scent transfer device of the present invention;

FIG. 2 is a cross-sectional view along line 2-2 of FIG. 1;

FIG. 3 is a cross-sectional view along line 3-3 of FIG. 2;

FIG. 4 is a cross-sectional view along line 4-4 of FIG. 2;

FIG. 5 is a cross-sectional view along line 5-5 of FIG. 4;

FIG. 6 is a cross-sectional view along line 6-6 of FIG. 2;

FIG. 7 illustrates a scent transfer pad utilized in the present invention;

FIGS. 8-9 illustrate a second embodiment of the present invention;

FIG. 10 illustrates a third embodiment of the present invention;

FIG. 11 is a perspective view of a fourth embodiment of the device of the present invention;

FIG. 12 is an exploded perspective view of the fourth embodiment of the present invention;

FIG. 13 is a cross-sectional view along line 13-13 of FIG. 11;

FIG. 14 is a cross-sectional view along line 14-14 of FIG. 13; and

FIG. 15 is a rear view of the device shown in FIG. 11.

### DESCRIPTION OF THE INVENTION

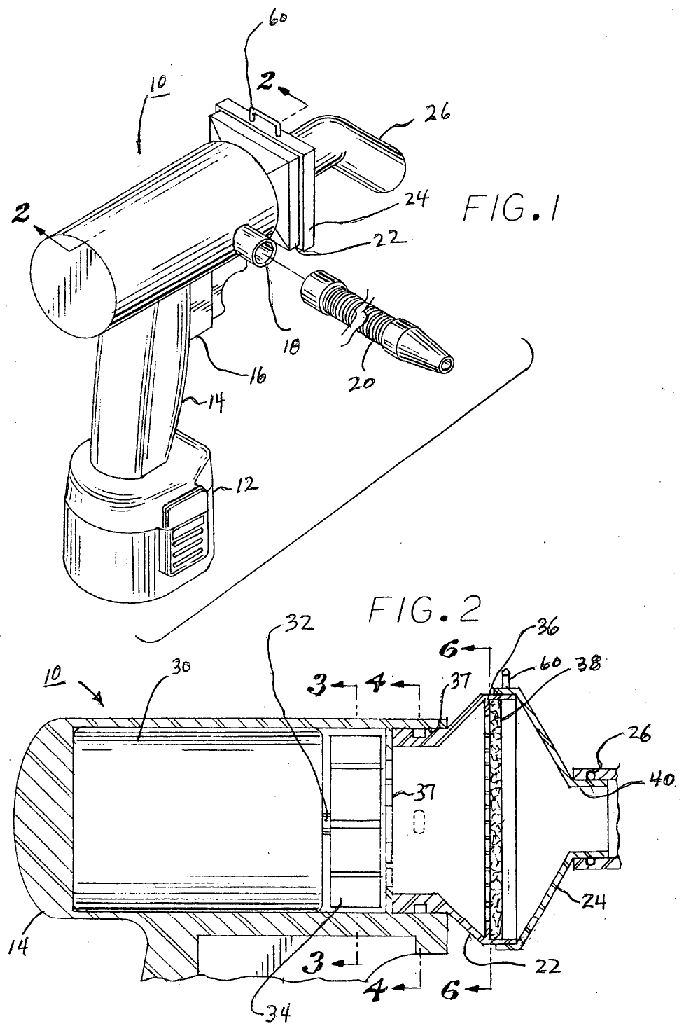

Referring now to FIG. 1, the components forming the scent transfer unit 10 according to the teachings of the present invention is illustrated.

In particular, unit 10 comprises battery pack 12, a housing 14, preferably fabricated from plastic, a variable speed trigger 16, an exhaust port 18 with an optional nozzle 20 for use as a blower to remove debris and dust from an item, a sterile pad nozzle holder 22, a swivel nozzle holder 24 and swivel nozzle 26.

FIG. 2 is a cross-sectional view illustrating the main components of the present invention.

A motor 30 is positioned within the upper portion of housing 14 as illustrated, shaft 32 of motor 30 being coupled to fan 34 and apertured finger protector screen 37. Sterile pad holder 22 is removably mounted within the inner surface 36 of housing 14. Sterile pad holder 22 includes an apertured frame member 37 that supports a sterile pad 38. Swivel nozzle 24 includes a neck portion 40; flexible swivel nozzle 26 is hard pressed to fit snugly over neck portion 40. Pad holder 22 is a separate component that can be removed from housing 14. Sterile pad 38 is inserted into pad holder 22 and held in place by a clip. Swivel nozzle holder 24 snaps onto pad holder 22 using clip 60.

In operation, device 10, charged by battery pack 12, is positioned in a manner such that nozzle 26 is adjacent an item to be examined for scent. A user then engages trigger 16 such that current is supplied to motor 30. Shaft 32 of motor 30 then rotates which in turn rotates fan 34. The air generated by the rotation of fan 34 is such that a vacuum is created, drawing air with scent contained therein, through nozzle 26, pad 38, frame member 36 and through exhaust port 18. Pad holder 22 is then removed from housing 14, nozzle holder 24 is removed from pad holder 22 and the hold-down clip holding pad 38 against apertured frame member 36 is opened and pad 38 is removed and placed in a sterilized evidence bag.

Pad holder 22 comprises an upper head portion 39 that has a square shaped housing portion having sides 41, 42, 43, and 44 and base portion 46 having a plurality of apertures 48 formed therein. It should be noted that other pad holder shapes can be utilized, such as rectangular shapes. A sterile pad 38, when the unit 10 is ready for operation, is secured within housing portion adjacent base portion 46 by a metal clip (not shown). The details of the metal clip and how it secures pad 38 against apertured housing 36 is disclosed in application Ser. No. 11/545,941, the teachings of which necessary for an understanding of the present invention being incorporated herein by reference.

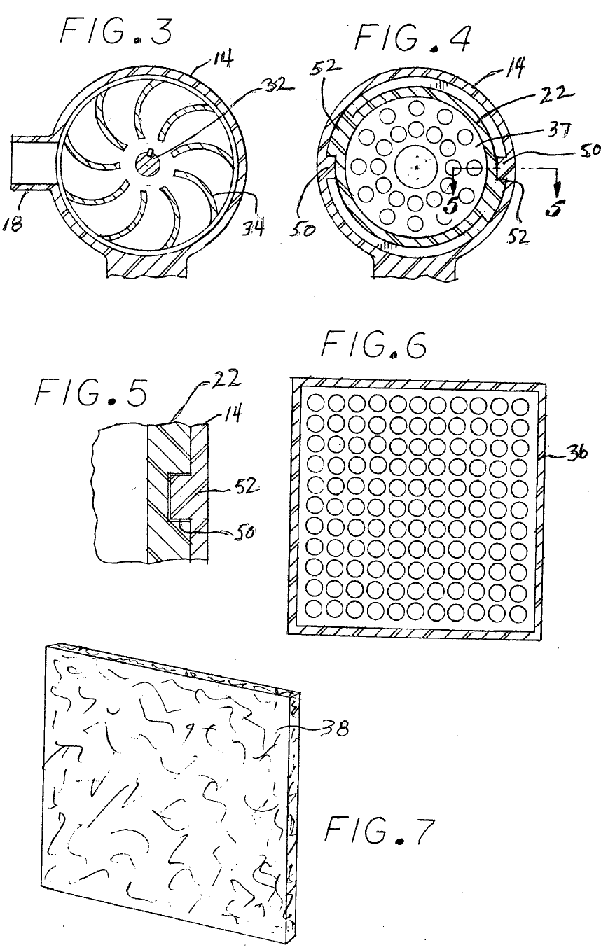

FIGS. 4 and 5 illustrates how sterile pad nozzle component holder 22 is secured and aligned with housing 14, recessed openings 50 on the interior surface of housing 14 engaging the edges of projections 52 formed on component holder 22.

FIG. 6 is a plan view of apertured housing 36 and FIG. 7 is a perspective view showing scent pad 38.

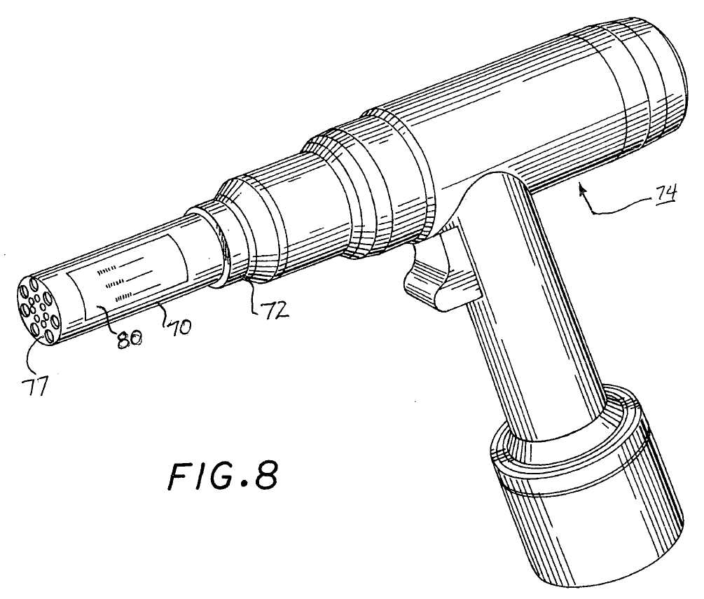

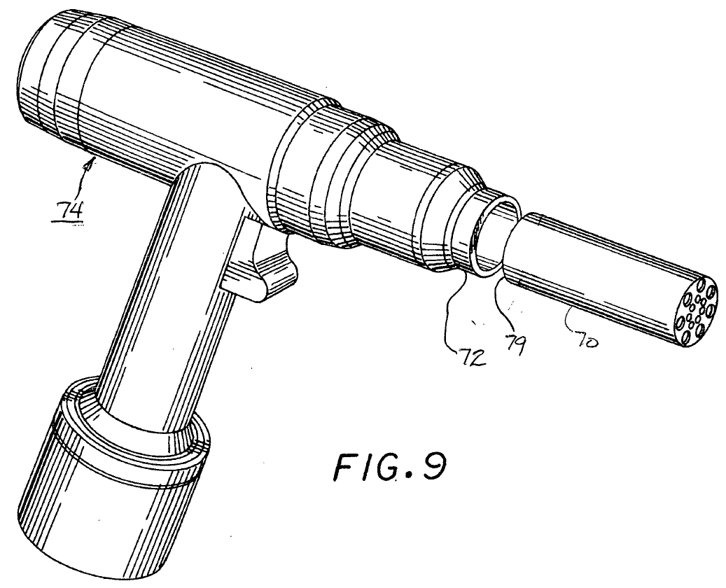

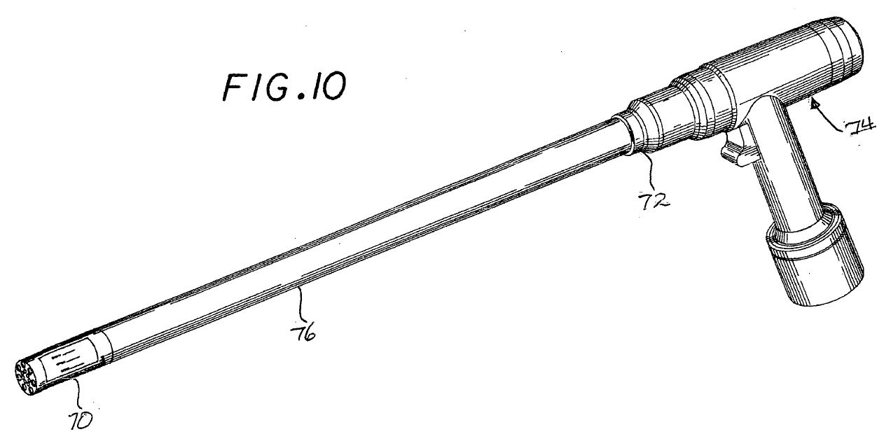

FIGS. 8 and 9 discloses another embodiment of the present invention. In particular, a cartridge, or capsule, 70 is used to collect scent in lieu of component holder 22. Single use capsule 70 is fabricated from sterile glass or plastic that is disposable. Removable caps are placed on both ends that are removed when collecting the scent sample and re-sealed thereafter for laboratory testing. A circular sterile pad is secured within capsule 70 and the capsule is inserted into end 72 of housing 74 and secured in place. One end of the capsule is punctured when inserted into housing 74 to indicate usage and avoiding possible reuse/cross contamination.

The pre-packaged cartridge 70 is pressed into the drill gun housing 74 and held in place via an o-ring or other compression device. The drill gun housing contains a stainless steel device the pieces the seal 79 of cartridge 70 when it is inserted into the front of housing 74 of the other end of cartridge 70 has a protective seal 79. When cartridge 70 is inserted into housing 14, seal 79 is pierced. The use removes seal 77 which enables human scent to flow into cartridge 70. The scent pad within cartridge 70 is then removed for lab testing. After the scent is tested, cartridge 70 is removed from housing 74 and the two ends thereof are then capped. The appropriate information on the testing event can be entered onto cartridge label 80.

FIG. 10 illustrates a modification to the scent transfer unit shown in FIGS. 8 and 9. In particular, a hollow extension tube 76 is positioned between capsule 70 and end 72 of housing 74 to distance the scent intake location from the exhaust port (not shown in the figure) to minimize contamination of motor 30 and impeller, or fan, 34 within the housing 74.

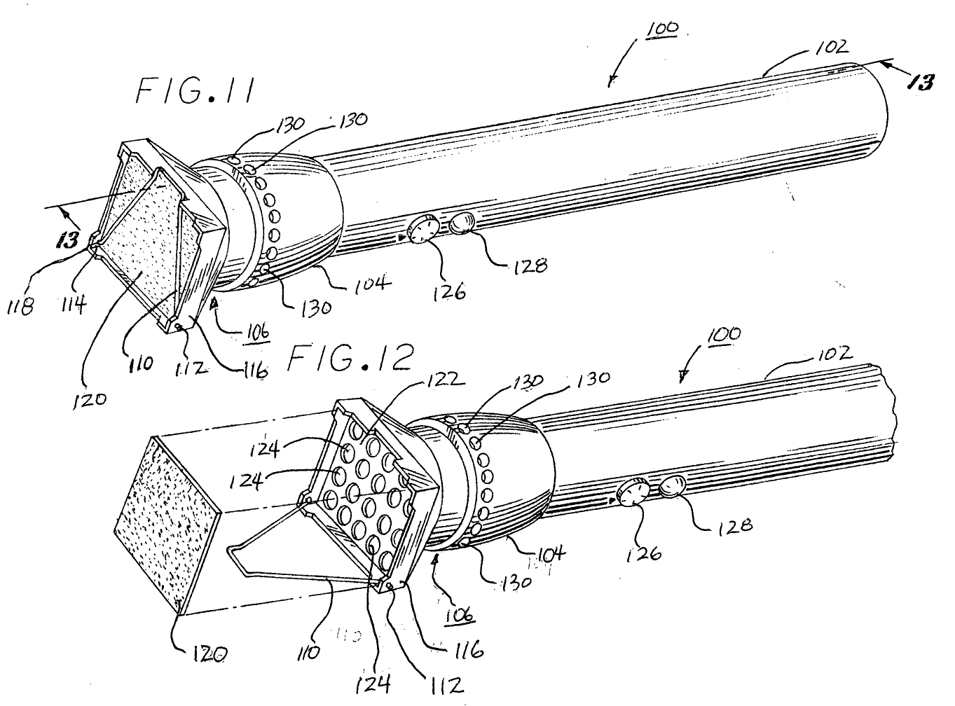

Referring now to FIGS. 11 and 12, a fourth embodiment of the present invention is illustrated.

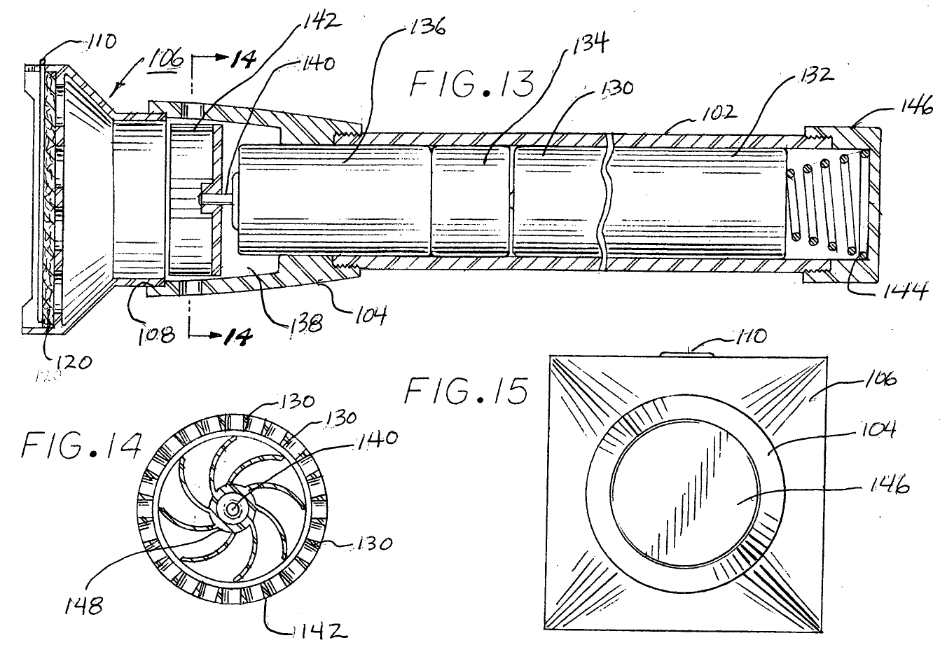

In particular, a scent transfer unit 100 comprising an elongated, cylindrically shaped housing portion 102 and a cone shaped portion 104 screwable onto portion 102 is illustrated, portions 102 and 104 in combination having a flash light shape. A pad holder 106, identical to pad holder 22 shown in FIG. 1, is sized to be inserted into the opening formed in the front portion of cone shaped portion 104 and positioned against a circular abutment 108 formed in the interior surface of portion 104 as shown in FIG. 13. Pad holder 106 includes a metal clip 110 having ends 112 and 114 extending through holes formed in the sides 116 and 118 of holder 106, surface 122 having a plurality of openings, or apertures, 124 formed therein. A motor rotary speed control dial 126 and an on/off switch 128 are formed on cylindrical portion 102 as illustrated. Cone shaped portion 104 has a plurality of venting apertures 130 formed around the circumference.

As shown in FIG. 13, within housing 102 are three “C” or “D” type batteries 130 and 132 (only two batteries are illustrated), electronic motor speed control module 134 and motor 136, motor 136 extending partially within opening 138 formed within portion 104. Shaft 140 of motor 136 is coupled to and drives fan 142, fan 142 creating a vacuum when activated. A spring 144 applies tension to the batteries when battery end cap 146 is screwed onto the end of housing 102 as illustrated in FIG. 13.

FIG. 14 shows more details of vacuum fan 142, fan 142 comprising a plurality (eight in the embodiment illustrated) fan blades mounted to hub 148.

FIG. 15 is a rear plan view of device 100 showing end cap 146, cone shaped portion 104, pad holder 106 and clips 110.

Scent pad holder 106 is similar to the one set forth in co-pending application Ser. No. 11/545,941 referred to hereinabove. It is Teflon coated and has clip spring 110 that holds the sterile 2″×2″ pad (or other sized pads) that may be required. Scent pad holder 106 press fits into the end of the housing 104 so that it can easily be removed for cleaning (alcohol is the preferred cleaning agent). Housing 104 is screwed onto housing 102.

The user un-clips the sterile pad holder clip 110 from scent pad holder 106 and it hinges out of the way so that the user could place the sterile pad 120 on the screen surface 122. Clip 110 is then snapped back into place to keep the sterile pad 120 from falling out.

In operation, a user pushes the on button switch 128 to energize scent transfer unit 100, the front of the unit being placed adjacent the area where the scent to be collected is located. The user then adjusts dial 126 to control the speed of motor 136 which in turn controls the amount of vacuum generated. The scent then picked up by unit 100 is collected on pad 120, clip 110 is hinged out of the way and pad 120 removed from pad holder 106. Pad 120 can then be deposited in a sterile evidence container for future examination.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A portable hand held device for collecting scent evidence comprising:
a housing;
a motor positioned within said housing and having an output shaft;
means for engaging said motor;
a fan driven by said output shaft, a vacuum being created when said motor is energized; and
a member for holding a sterile pad, said member being removably secured to said housing;

2. The device of claim 1 wherein said pad holder is positioned adjacent an object to be examined for scent evidence, the vacuum created by said energized motor causing the scent from said object to be collected on said sterile pad.

3. The device of claim 2 wherein said pad member is removed from said holding member and stored in a collection device after the scent is collected.

4. The device of claim 1 further including a nozzle coupled to said holding member and positioned adjacent an object to be examined for scent evidence, the vacuum created by said energized motor causing the scent from said object to be collected by said sterile pad.
